(19) United States
(12) Patent Application Publication
(10) Pub. No.: US 2026/0340055 A1
(43) Pub. Date: Oct. 29, 2026

(54) SEARCH RESULT PRESENTATION METHOD AND APPARATUS, COMPUTER DEVICE, AND STORAGE MEDIUM

(71) Applicant: Beijing Zitiao Network Technology Co., Ltd., Beijing (CN)

(72) Inventors: Lin YAN, Beijing (CN); Chao QIAO, Beijing (CN); Xin YU, Beijing (CN)

(21) Appl. No.: 18/995,726

(22) PCT Filed: Nov. 29, 2023
(86) PCT No.: PCT/CN2023/135012

§ 371 Date: Jan. 16, 2025

(30) Foreign Application Priority Data
Dec. 1, 2022 (CN) 202211531138.5

(51) Int. Cl. G06F 16/9538; G06F 16/958

(52) U.S. Cl. CPC G06F 16/9538; G06F 16/958

(57) ABSTRACT

The present disclosure provides a search result presentation method and apparatus, a computer device, and a storage medium. The method includes: acquiring a search result matching search information in response to receiving the search information, where the search result includes one of key information and structured information of target webpage content; and presenting the search result in a presentation form corresponding to the search result, where the presentation form corresponding to the key information includes prominently presenting a keyword in the key information that matches the search information, and the presentation form corresponding to the structured information includes presenting field information of a plurality of key fields of the target webpage content in a structured manner.

### CROSS-REFERENCE TO RELATED APPLICATIONS

This application is the U.S. National Stage of International Application No. PCT/CN2023/135012, filed on Nov. 29, 2023, which claims priority to Chinese Patent Application No. 202211531138.5, filed on Dec. 1, 2022, entitled “SEARCH RESULT PRESENTATION METHOD AND APPARATUS, COMPUTER DEVICE AND STORAGE MEDIUM”, both of which are incorporated herein by reference in their entireties.

### TECHNICAL FIELD

The present disclosure relates to the field of computer technology, and in particular, to a search result presentation method and apparatus, a computer device, and a storage medium.

### BACKGROUND

With the continuous development of Internet technologies, a user can search for webpage content that the user is interested in using a search engine.

When webpage search results are presented, individual search results are often presented in the same presentation form on a search result presentation page. Under the same presentation form, the content presented in some search results may not meet the search needs of the user, resulting in the user's misjudgment on whether the search results meet the user's search needs. For example, the webpage content of a certain webpage may contain effective information that well matches the search needs of the user, but due to limitations of the presentation form, part of the content of the webpage presented in the search result does not reflect the effective information well.

### SUMMARY

The embodiments of the present disclosure provide at least a search result presentation method and apparatus, a computer device, and a storage medium.

In a first aspect, an embodiment of the present disclosure provides a search result presentation method, including:
in response to receiving search information, acquiring a search result matching the search information, where the search result includes one of key information and structured information of target webpage content; and
presenting the search result in a presentation form corresponding to the search result,
where the presentation form corresponding to the key information includes prominently presenting a keyword in the key information that matches the search information, and the presentation form corresponding to the structured information includes presenting field information of a plurality of key fields of the target webpage content in a structured manner.

In one possible implementation, the search result matching the search information is determined by:
acquiring individual search results, where the individual search results include the key information and the structured information; and
selecting, from the key information and the structured information, information with a higher corresponding correlation degree as the search result matching the search information based on a first correlation degree between the key information and the search information and a second correlation degree between the structured information and the search information.

In one possible implementation, the structured information is predetermined by:
extracting the structured information corresponding to the target webpage content based on a key field combination set for a webpage category to which the target webpage content belongs, for the target webpage content, where the structured information includes field information of a plurality of key fields indicated by the key field combination.

In one possible implementation, the key information is determined by:
extracting individual text segments in the target webpage content;
determining a correlation degree between each text segment and the search information; and
selecting a text segment with a highest corresponding correlation degree as the key information, or selecting at least one text segment with a corresponding correlation degree greater than a first set threshold and integrating the at least one text segment into the key information.

In one possible implementation, selecting, from the key information and the structured information, the information with the higher corresponding correlation degree as the search result matching the search information based on the first correlation degree between the key information and the search information and the second correlation degree between the structured information and the search information includes:
inputting the search information, and the key information and the structured information corresponding to the search information into a pre-trained neural network model to obtain a first correlation score for characterizing the first correlation degree and a second correlation score for characterizing the second correlation degree output by the neural network model; and
presenting information with a higher correlation score as the search result matching the search information based on the first correlation score and the second correlation score.

In one possible implementation, the neural network model is trained according to the following steps:
acquiring sample search information, sample key information and sample structured information of webpage content corresponding to the sample search information, and sample labels, where the sample labels are used to mark first sample correlation degrees between the sample key information and the sample search information and second sample correlation degrees between the sample structured information and the sample search information;
inputting the sample search information, the sample key information, and the sample structured information into the neural network model to be trained to obtain first sample correlation scores for characterizing the first sample correlation degrees and a second sample correlation scores for characterizing the second sample correlation degrees output by the neural network model; and
determining a loss value of a current training based on the first sample correlation scores, the second sample correlation scores, and the sample labels, and adjusting parameters of the neural network model to be trained based on the loss value.

In one possible implementation, prominently presenting the keyword in the key information that matches the search information includes:
performing word segmentation on the key information to obtain individual segmented words; and
calculating a correlation degree between each obtained segmented word and the search information, and setting a segmented word with a correlation degree between the segmented word and the the search information greater than a second set threshold in the key information as in a prominent presentation form.

In a second aspect, an embodiment of the present disclosure further provides a search result presentation apparatus, including:
an acquisition module, configured to acquire a search result matching search information in response to receiving the search information, where the search result includes one of key information and structured information of target webpage content; and
a presentation module, configured to present the search result in a presentation form corresponding to the search result,
where the presentation form corresponding to the key information includes prominently presenting a keyword in the key information that matches the search information, and the presentation form corresponding to the structured information includes presenting field information of a plurality of key fields of the target webpage content in a structured manner.

In one possible implementation, the acquisition module is configured to acquire the search result matching the search information by:
acquiring individual search results, where the individual search results include the key information and the structured information; and
selecting, from the key information and the structured information, information with a higher corresponding correlation degree as the search result matching the search information based on a first correlation degree between the key information and the search information and a second correlation degree between the structured information and the search information.

In one possible implementation, the acquisition module is further configured to predetermine the structured information by:
extracting the structured information corresponding to the target webpage content based on a key field combination set for a webpage category to which the target webpage content belongs, for the target webpage content, where the structured information includes field information of a plurality of key fields indicated by the key field combination.

In one possible implementation, the acquisition module is further configured to determine the key information by:
extracting individual text segments in the target webpage content;
determining a correlation degree between each text segment and the search information; and
selecting a text segment with a highest corresponding correlation degree as the key information, or selecting at least one text segment with a corresponding correlation degree greater than a first set threshold and integrating the at least one text segment into the key information.

In one possible implementation, when selecting, from the key information and the structured information, the information with the higher corresponding correlation degree as the search result matching the search information based on the first correlation degree between the key information and the search information and the second correlation degree between the structured information and the search information, the acquisition module is configured to:
inputting the search information, and the key information and the structured information corresponding to the search information into a pre-trained neural network model to obtain a first correlation score for characterizing the first correlation degree and a second correlation score for characterizing the second correlation degree output by the neural network model; and
presenting information with a higher correlation score as the search result matching the search information based on the first correlation score and the second correlation score.

In one possible implementation, the acquisition module is further configured to train the neural network model according to the following steps:
acquiring sample search information, sample key information and sample structured information of webpage content corresponding to the sample search information, and sample labels, where the sample labels are used to mark first sample correlation degrees between the sample key information and the sample search information and second sample correlation degrees between the sample structured information and the sample search information;
inputting the sample search information, the sample key information, and the sample structured information into the neural network model to be trained to obtain first sample correlation scores for characterizing the first sample correlation degrees and second sample correlation scores for characterizing the second sample correlation degree output by the neural network model; and
determining a loss value of a current training based on the first sample correlation scores, the second sample correlation scores, and the sample labels, and adjusting parameters of the neural network model to be trained based on the loss value.

In one possible implementation, when prominently presenting the keyword in the key information that matches the search information, the presentation module is configured to:
perform word segmentation on the key information to obtain individual segmented words; and
calculate a correlation degree between each obtained segmented word and the search information, and set a segmented word with a correlation degree between the segmented word and the search information greater than a second set threshold in the key information as in a prominent presentation form.

In a third aspect, an embodiment of the present disclosure further provides a computer device, including: a processor, a storage device, and a bus, where the storage device has a machine-readable instruction executable by the processor stored thereon, the processor communicates with the storage device through the bus when the computer device operates, and the machine-readable instruction, when executed by the processor, performs the steps in the first aspect or any possible implementation of the first aspect.

In a fourth aspect, an embodiment of the present disclosure further provides a computer-readable storage medium having a computer program stored thereon, where the computer program, when executed by a processor, performs the steps in the first aspect or any possible implementation of the first aspect.

In the search result presentation method, apparatus, computer device, and storage medium provided by the embodiments of the present disclosure, the search result matching the search information may include one of the key information and the structured information of the webpage content, and the search result is presented in the presentation form corresponding to the search result. In the embodiments of the present disclosure, by presenting the field information of the key field in the webpage content in a structured manner or prominently presenting the key information that matches the search information, information in a webpage can be well refined and presented, improving the user's efficiency of browsing the search result. Moreover, in the embodiments of the present disclosure, the information that best matches the search needs in the key information and the structured information corresponding to the webpage content may be used as the search result and presented in the presentation form corresponding thereto, instead of presenting solely either the key information or the structured information in a single presentation form, which can make the presentation form of the search result more flexible and make the presented search result better match the search information, thereby better meeting the search needs of the user.

In order to make the above objects, features, and advantages of the present disclosure more comprehensible, the embodiments are described in detail below with reference to the drawings.

### BRIEF DESCRIPTION OF THE DRAWINGS

In order to describe the technical solutions in the embodiments of the present disclosure more clearly, the drawings required in the embodiments will be briefly described hereunder. The drawings herein are incorporated into and constitute a part of the present specification, and these drawings illustrate the embodiments consistent with the present disclosure and are used in conjunction with the specification to explain the technical solutions of the present disclosure. It should be understood that the following drawings only illustrate some embodiments of the present disclosure, and thus should not be considered as limiting the scope of the present disclosure. For those of ordinary skill in the art, other related drawings may be obtained based on these drawings without creative effort.

FIG. 1 is a flowchart of a search result presentation method according to an embodiment of the present disclosure.

FIG. 2a is a schematic diagram of a search result presentation page in the search result presentation method according to an embodiment of the present disclosure.

FIG. 2b is a schematic diagram of another search result presentation page in the search result presentation method according to an embodiment of the present disclosure.

FIG. 3 is an architectural schematic diagram of a search result presentation apparatus according to an embodiment of the present disclosure.

FIG. 4 is a structural schematic diagram of a computer device according to an embodiment of the present disclosure.

### DETAILED DESCRIPTION

In order to make the objectives, technical solutions, and advantages of the embodiments of the present disclosure clearer, the technical solutions in the embodiments of the present disclosure will be described clearly and comprehensively below with reference to the drawings in the embodiments of the present disclosure. Apparently, the described embodiments are merely some rather than all of the embodiments of the present disclosure. Generally, components of the embodiments of the present disclosure described and shown in the drawings hereof may be arranged and designed in various different configurations. Therefore, the following detailed description of the embodiments of the present disclosure provided in the drawings is not intended to limit the claimed scope of the present disclosure, but merely represents selected embodiments of the present disclosure. All other embodiments obtained by those of ordinary skill in the art based on the embodiments of the present disclosure without creative effort shall fall within the protection scope of the present disclosure.

It should be noted that the same reference numerals and letters in the following drawings denote similar items. Therefore, once an item is defined in one accompanying drawing, it does not need to be further defined and explained in subsequent drawings.

The term “and/or” used herein is merely used to describe an association relationship, indicating that three relationships may exist. For example, “A and/or B” may indicate the following three cases: A exists alone, A and B exist at the same time, and B exists alone. In addition, the term “at least one” used herein means any one of multiple or any combination of at least two of multiple. For example, “at least one of A, B, and C” may mean including any one or more elements selected from a set consisting of A, B, and C.

It can be understood that before using the technical solutions disclosed in the embodiments of the present disclosure, a user should be informed of the type, range of use, use scenario, and the like of the personal information involved in the present disclosure in an appropriate manner in accordance with relevant laws and regulations, and the user's authorization should be obtained.

For example, in response to receiving an active request from a user, prompt information is sent to the user to explicitly prompt the user that the operation requested by the user will require acquisition and use of the user's personal information. Thus, the user can independently choose, according to the prompt information, whether to provide personal information to software or hardware such as an electronic device, an application, a server, or a storage medium that performs the operations of the technical solutions of the present disclosure.

As an optional but non-limiting implementation, the manner of sending the prompt information to the user in response to receiving the active request from the user may be, for example, a pop-up window in which the prompt information may be presented in text. In addition, the pop-up window may further include a selection control for the user to choose whether to “agree” or “disagree” to provide the personal information to the electronic device.

It can be understood that the above process of notifying and obtaining the user's authorization is only illustrative and does not limit the implementations of the present disclosure. Other manners that satisfy the relevant laws and regulations may also be applied to the implementations of the present disclosure.

The embodiments of the present disclosure provide a search result presentation method, an apparatus, a computer device, and a storage medium. When it is necessary to present a search result related to webpage content, it is possible to determine which one of pre-extracted key information and structured information of the webpage content best matches the search information. The search result that is finally presented may be the information that best matches the search information in the key information and the structured information of the webpage content, and the search result is presented in a presentation form matching the search result. In this way, by presenting the field information of the key field in the webpage in a structured manner or prominently presenting the keyword that matches the search information, the information in the webpage can be well refined and presented, improving the user's efficiency of browsing the search result. Moreover, in the embodiments of the present disclosure, information that best matches the search needs may be selected from the key information and the structured information corresponding to the webpage content as the search result, instead of presenting solely either the key information or the structured information in a single presentation form, which can make the presentation form of the search result more flexible and make the presented search result better match the search information, thereby better meeting the search needs of the user.

To facilitate understanding of the embodiments, a search result presentation method disclosed in the embodiments of the present disclosure will be described in detail first. The search result presentation method provided in the embodiments of the present disclosure is generally performed by a computer device with a certain computing power, such as a terminal device, a server, or other processing device. The terminal device may be a smart terminal device with a display function, such as a smartphone, a tablet computer, or a smart wearable device. In some possible implementations, the search result presentation method may be implemented by a processor calling a computer-readable instruction stored in a memory.

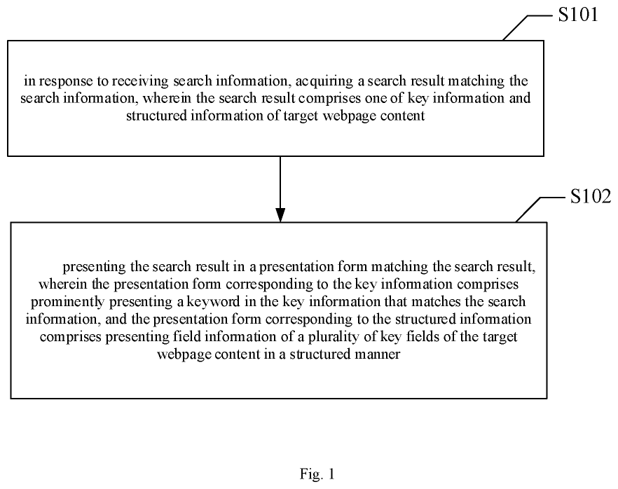

As shown in FIG. 1, which is a flowchart of a search result presentation method according to an embodiment of the present disclosure, the method includes S101 and S102.

S101: acquiring a search result matching search information in response to receiving the search information, where the search result includes one of key information and structured information of target webpage content.

S102: presenting the search result in a presentation form corresponding to the search result, where the presentation form corresponding to the key information includes prominently presenting a keyword in the key information that matches the search information, and the presentation form corresponding to the structured information includes presenting field information of a plurality of key fields of the target webpage content in a structured manner.

The above steps make it possible to extract key information and structured information corresponding to the webpage content in advance; and after the search information is received, information that best matches the search needs may be selected from the key information and structured information corresponding to the webpage content as the search result and presented in the presentation form corresponding thereto, where if the key information is selected for presentation, the keyword answering the question of the search information therein may be prominently presented, such as in red and bold, and if the structured information is selected for presentation, the pre-extracted field information of the plurality of key fields of the webpage content may be presented in a configured structured style. This can make the presentation form of the search result more flexible and make the presented search result better match the search information, thereby better meeting the search needs of the user.

The above steps are described in detail below.

For S101,
the search information may be information inputted by a user in a search bar on a search page, or search information determined based on a recommended search term; and the target webpage content is the webpage content in a target webpage that matches the search information, and the webpage content of the target webpage may contain answer information corresponding to the search information.

The key information may contain summary content such as the title and the content summary of the target webpage content; and the structured information is used to present information of a plurality of key fields in the webpage content in a structured manner, where the key fields may include the cover, the title, the category, the author, the update status, the table of contents, etc., and the structured information may be presented in the form of a structured information card, etc.

In practical applications, before the user uses the search information to search, it is possible to predetermine the key information and the structured information of the respective webpage content, so that when the user uses the search information to search, the key information and the structured information of the webpage content in the search result can be quickly acquired.

The manner for determining the structured information and the manner for determining the key information will be described below, respectively.

1. For the structured information:

For the target webpage content, the structured information corresponding to the target webpage content may be extracted based on a key field combination set for a webpage category to which the target webpage content belongs.

The structured information includes field information of a plurality of key fields indicated by the key field combination.

Specifically, the different field information corresponds to webpage content at different positions in a webpage, and different webpage categories may correspond to different fields, so that different webpage content may be extracted from webpages of different categories.

In addition, since the structured information extraction needs to be performed based on the key field combination set for the webpage category to which the target webpage content belongs, it is also necessary to predetermine the webpage category of the target webpage and determine the key field combination from the plurality of fields corresponding to the target webpage.

In one possible implementation, a pre-trained webpage category determination model may be used to perform webpage category recognition on respective webpages, so that the webpage categories of the respective webpages may be determined in batch.

Here, the webpage category determination model may be a neural network model that can be used to perform a classification task, such as a bidirectional encoder representations from transformers (BERT) model.

Input data of the webpage category determination model may be obtained after data construction is performed on the webpage content of the target webpage; and the input data obtained after the data construction is used to characterize content and attribute information of respective content nodes in the network content, where the attribute information includes depth information and position information, the depth information is used to characterize a hierarchical relationship between the content node and other content nodes, and the position information is used to characterize a layout position of the content node in a webpage.

Specifically, when the data construction is performed, firstly, depth-first traversal algorithm may be used to traverse a node tree corresponding to the target webpage, to determine the depth information and the position information corresponding to the respective content nodes, where the node tree is generated based on webpage codes corresponding to the target webpage; and the content of the respective content nodes, the depth information corresponding to the respective content nodes, and the position information are spliced according to a preset data construction order, to obtain the input data corresponding to the target webpage.

In addition, when the webpage category determination model is trained, sample input data generated after data construction is performed on sample webpages may be input into the webpage category determination model to be trained, to obtain sample webpage categories output by the webpage category recognition model, a loss value of a current training is determined based on the sample webpage categories and webpage category labels corresponding to the sample webpages, and network parameters of the webpage category determination model are adjusted based on the loss value, until the number of parameter adjustments reaches a preset number of adjustments, and/or the network precision of the webpage category determination model meets a preset precision requirement.

Furthermore, after the webpage category of each webpage is determined according to the above-mentioned webpage category determination model, a key field combination corresponding to each webpage may be configured, to extract the structured information corresponding to the webpage content in each webpage according to a field access path corresponding to each key field in the key field combination; in order to improve the configuration efficiency of the key field combination, the same key field combination may also be configured for webpages belonging to the same webpage group, and the webpage group may be composed of webpages with partially the same webpage addresses.

In this way, when the structured information corresponding to the webpage content is extracted, the target webpage content of the target webpage may be extracted according to the key field combination corresponding to the webpage category to which the target webpage belongs, so as to obtain the structured information corresponding to the target webpage content.

2. For the key information:

Here, the key information may be determined through the following steps A1 to A3.

A1: extracting individual text segments in the target webpage content.

Here, text segmentation may be performed on the target webpage content to obtain the individual text segments in the target webpage content.

Specifically, when the text segmentation is performed on the target webpage content, the text processing may be performed according to a preset text segmentation length to obtain the individual text segments in the target webpage content.

Alternatively, when the text segmentation is performed on the target webpage content, the text segmentation may also be performed according to target punctuation marks in the target webpage content. The text content between the Nth target punctuation mark and the (N+1)th target punctuation mark may be used as one text segment, where N is a positive integer, the text content before the first target punctuation mark may be used as one text segment, and the target punctuation mark may be a symbol such as a comma or a period.

Alternatively, when the text segmentation is performed on the target webpage content, the text segmentation may also be performed from a text semantic perspective through a pre-trained text segmentation model, to obtain the individual text segments in the target webpage content. That is, the text segmentation model performs semantic recognition to segment the content with indivisible semantics in the target webpage content into one text segment, and to segment content with different semantics into different text segments. Word segmentation may also be performed on the text in advance, and input data of the text segmentation model may be a word segmentation result corresponding to the webpage content, that is, a plurality of words to be combined obtained after the word segmentation is performed on the webpage content. The text segmentation model may perform semantic recognition on the words to be combined, and combine the words to be combined that have the same semantics, and/or similar semantics, and/or related semantics and are close in position in the webpage content to obtain at least one word combination, and each word combination may form one text segment.

A2: determining a correlation degree between each text segment and the search information.

Here, the correlation degree between the text segment and the search information may be determined by calculating an Euclidean distance between feature representation vectors of the two, an edit distance between characters of the two, etc., or the semantic correlation degree between the two may be directly calculated through a semantic recognition model. The embodiments of the present disclosure do not specifically limit the manner for calculating the similarity.

A3: selecting a text segment with a highest corresponding correlation degree as the key information, or selecting at least one text segment with a corresponding correlation degree greater than a first set threshold and integrating the at least one text segment into the key information.

Exemplarily, taking the correlation degrees between the text segments 1 to 5 and the search information being 0.6, 0.7, 0.5, 0.4, and 0.9 as an example, the text segment 5 with the highest corresponding correlation degree may be used as the key information. Alternatively, the text segment 2 and the text segment 5 with correlation degrees greater than the first set threshold 0.65 may also be selected, and the text segment 2 and the text segment 5 are integrated according to the arrangement order of the respective text segments in the webpage content, and the integrated text content is used as the key information.

In practical applications, the target webpage content may correspond to both the key information and the structured information. However, if the key information and the structured information corresponding to the target webpage content are simultaneously presented on a search result presentation page, too much content may be presented, which may affect the presentation effect of subsequent other search results.

In one possible implementation, when the search result matching the search information is acquired, the following steps B1 and B2 may be included.

B1: acquiring individual search results, where the individual search results include the key information and the structured information.

Here, for any search result, the search result may include key information of the webpage content corresponding to the search result and structured information of the webpage content corresponding to the search result.

B2: selecting, from the key information and the structured information, information with a higher corresponding correlation degree as the search result matching the search information based on a first correlation degree between the key information and the search information and a second correlation degree between the structured information and the search information.

Here, the first correlation degree and the second correlation degree may be a text correlation degree and/or a semantic correlation degree.

In one possible implementation, when selecting, from the key information and the structured information, the information with the higher corresponding correlation degree as the search result matching the search information based on the first correlation degree between the key information and the search information and the second correlation degree between the structured information and the search information, the following steps B21 and B22 may be included.

B21: inputting the search information, and the key information and the structured information corresponding to the search information into a pre-trained neural network model to obtain a first correlation score for characterizing the first correlation degree and a second correlation score for characterizing the second correlation degree output by the neural network model.

Here, the network type of the pre-trained neural network model may be, for example, a bidirectional encoder representations from transformers (BERT) model.

B22: presenting information with a higher correlation score as the search result matching the search information based on the first correlation score and the second correlation score.

Exemplarily, taking the first correlation degree score for characterizing the first correlation degree between the key information and the search information being 0.6 and the second correlation degree score for characterizing the second correlation degree between the structured information and the search information being 0.8 as an example, the structured information with a higher corresponding correlation score may be presented as the search result matching the search information.

Further, the neural network model may be trained according to the following steps C1 to C3.

C1: acquiring sample search information, sample key information and sample structured information of webpage content corresponding to the sample search information, and sample labels, where the sample labels are used to mark first sample correlation degrees between the sample key information and the sample search information and second sample correlation degrees between the sample structured information and the sample search information.

C2: inputting the sample search information, the sample key information, and the sample structured information into the neural network model to be trained to obtain first sample correlation scores for characterizing the first sample correlation degrees and second sample correlation scores for characterizing the second sample correlation degrees output by the neural network model.

C3: determining a loss value of a current training based on the first sample correlation scores, the second sample correlation scores, and the sample labels, and adjusting parameters of the neural network model to be trained based on the loss value.

Here, the loss value of a current training may include a first loss value and a second loss value, where the first loss value may be used to characterize a difference between the first sample correlation scores and the first sample correlation degrees marked by the sample labels, that is, whether the first sample correlation scores are the same as the marked correlation degrees; and the second loss value may be used to characterize a difference between the second sample correlation scores and the second sample correlation degrees marked by the sample labels, that is, whether the second sample correlation scores are the same as the marked correlation degrees.

Specifically, when the loss value is determined, weighted summation may be performed on the first loss value and the second loss value based on the first loss value, the second loss value, and a preset weight parameter, and the parameters of the neural network model are adjusted based on the loss value obtained after the weighted summation, until the number of parameter adjustments reaches a preset number of adjustments, and/or the network precision of the neural network model meets a preset precision requirement.

In this way, through the pre-trained neural network model, information with a higher correlation degree with the search information may be selected from the key information and the structured information corresponding to the webpage content as the search result matching the search information, thereby making the finally presented search result have a higher correlation degree with the search information, and improving the user's efficiency of browsing the search result.

For S102,
here, when the field information of the plurality of key fields of the target webpage content are presented in a structured manner, the field information of the plurality of key fields of the target webpage content may be presented in a structured manner according to a structured presentation template matching a network type of the target webpage.

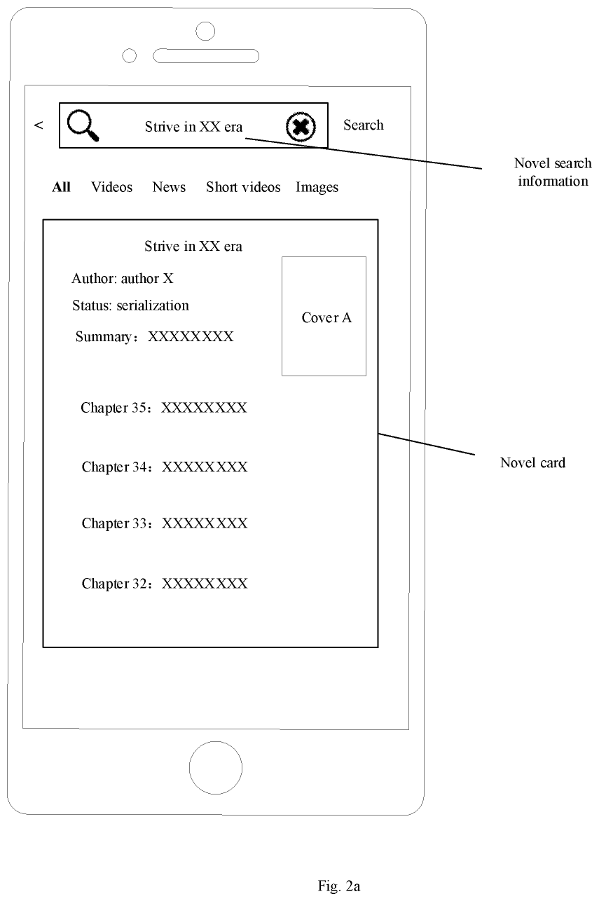

Exemplarily, a schematic diagram of a search result presentation page may be shown in FIG. 2a. In FIG. 2a, the search information inputted by the user is a novel search information “Strive in XX Era”, and the target webpage matching the search information is a webpage corresponding to a target novel. When the search result is presented, a structured presentation template matching the webpage category of the target webpage (i.e., a novel card) is used to present the structured information of the target webpage, and the presented structured information includes author information, status information, summary information, and the like. The content of the novel that is recently updated is also presented in the novel card, and the user can browse the content of the corresponding novel chapter by triggering the corresponding chapter.

In one possible implementation, when the keyword in the key information that matches the search information is prominently presented, the following steps D1 and D2 may be included.

D1: performing word segmentation on the key information to obtain individual segmented words.

Here, when the word segmentation is performed on the key information, a Chinese word segmentation (CWS) model may be used to perform the word segmentation on the key information, to obtain the individual segmented words after the word segmentation.

It should be noted that the embodiments of the present disclosure do not limit how to perform the word segmentation on the key information, as long as it can be implemented.

D2: calculating a correlation degree between each obtained segmented word and the search information, and setting a segmented word with a correlation degree greater than a second set threshold in the key information as a prominent presentation form.

Here, the correlation degree between the segmented word and the search information may include a text correlation degree such as an Euclidean distance and an edit distance, and/or a semantic correlation degree. When the correlation degree between the segmented word and the search information is determined, the calculation may be performed according to a preset correlation degree calculation formula. The embodiments of the present disclosure do not limit the correlation degree calculation formula to be selected, as long as it can be implemented in practical application. The prominent presentation form may include forms such as bold font, changing the font color, changing the background color of the area where the font is located, and increasing the font size.

Specifically, after the correlation degree between each segmented word and the search information is calculated, the segmented word with a correlation degree greater than the second set threshold with the search information or the first M segmented words in a descending order of the correlation degree in a correlation degree ranking queue may be set as in the prominent presentation form, where M is a preset positive integer.

Exemplarily, taking the correlation degrees between the segmented words 1 to 5 and the search information respectively being 0.6, 0.8, 0.5, 0.4, and 0.2 as an example, the segmented word 1 and the segmented word 2 greater than the second set threshold 0.55 may be used as segmented words that need to be prominently presented, and the presentation forms of the segmented word 1 and the segmented word 2 are set as the prominent presentation form, so as to prominently present the segmented word 1 and the segmented word 2 when the search result is presented. Alternatively, the segmented words may also be ranked in a descending order of the correlation degree, and the first 3 segmented words “segmented word 1”, “segmented word 2” , and “segmented word 3” in the correlation degree ranking queue obtained after ranking are used as segmented words that need to be prominently presented, and the presentation forms of the segmented word 1, the segmented word 2, and the segmented word 3 are set as the prominent presentation form, so as to prominently present the segmented word 1, the segmented word 2, and the segmented word 3 when the search result is presented.

Exemplarily, a schematic diagram of a search result presentation page may also be shown in FIG. 2b. In FIG. 2b, the search information inputted by the user is “XX Travelogue”, and the target webpage matching the search information includes a webpage corresponding to a target video work. When the search result is presented, a presentation style matching the webpage type of the target webpage is used to present the key information of the target webpage, and the keywords “XX Travelogue” and “TV drama” in the key information that match the search information are prominently presented. The key information presented in the video work card includes episode information, summary information, and the like.

In the search result presentation method provided by the embodiments of the present disclosure, by presenting the field information of the key field in the webpage content in a structured manner or prominently presenting the key information that matches the search information, information in a webpage can be well refined and presented, improving the user's efficiency of browsing the search result. Moreover, in the embodiments of the present disclosure, the information that best matches the search needs in the key information and the structured information corresponding to the webpage content may be used as the search result, instead of presenting solely either the key information or the structured information, which can make the presentation form of the search result more flexible and make the presented search result better match the search information, thereby better meeting the search needs of the user.

That is, in the embodiments of the present disclosure, for different search information, if the same webpage content is matched, the search result that is finally presented on the search result page may be the key information of the webpage content in some cases, and the structured information of the webpage content in some other cases. In this way, by selecting a search result that better matches the search information from the key information and the structured information of the same webpage content and presenting the search result in the matching presentation form, the presented search result can better match the search needs, and the user can accurately determine whether the webpage content meets the user's search needs, and then decide whether to further consume the detailed content of the webpage, thereby improving the user's efficiency of browsing the search result.

It can be understood by those skilled in the art that in the above methods of the specific implementations, the drafted sequence of the steps does not mean a strict execution sequence and does not constitute any limitation on the implementation process, and that the specific execution sequence of the steps should be determined by its function and possible internal logic.

Based on the same inventive concept, a search result presentation apparatus corresponding to the search result presentation method is further provided in the embodiments of the present disclosure. Since the principle for solving the problem by the apparatus in the embodiments of the present disclosure is similar to the search result presentation method in the embodiments of the present disclosure, for the implementation of the apparatus, reference may be made to the implementation of the method, and details are not repeated here.

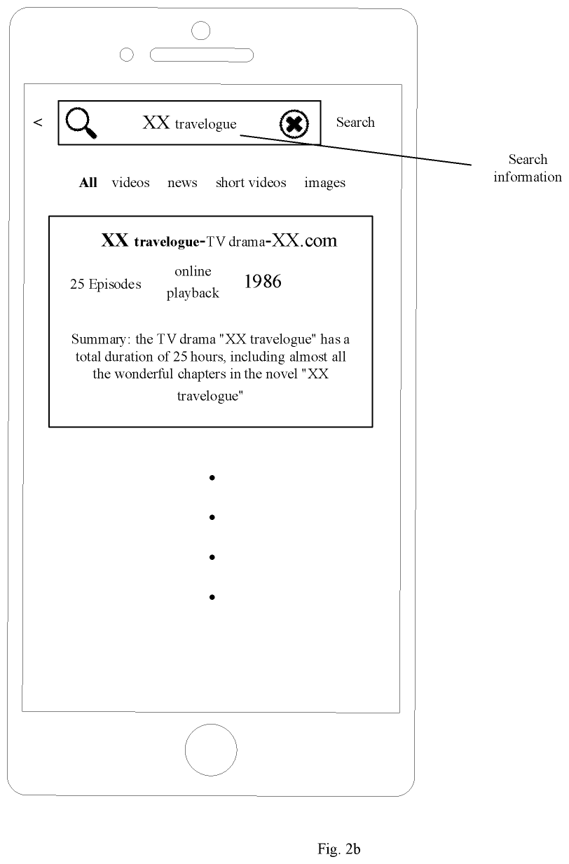

Referring to FIG. 3, which is an architectural schematic diagram of a search result presentation apparatus according to an embodiment of the present disclosure, the apparatus includes an acquisition module 301 and a presentation module 302.

The acquisition module 301 is configured to acquire a search result matching search information in response to receiving the search information, where the search result includes one of key information and structured information of target webpage content.

The presentation module 302 is configured to present the search result in a presentation form corresponding to the search result.

The presentation form corresponding to the key information includes prominently presenting a keyword in the key information that matches the search information, and the presentation form corresponding to the structured information includes presenting field information of a plurality of key fields of the target webpage content in a structured manner.

In one possible implementation, the acquisition module 301 is configured to acquire the search result matching the search information by:
acquiring individual search results, where the individual search results include the key information and the structured information; and
selecting, from the key information and the structured information, information with a higher corresponding correlation degree as the search result matching the search information based on a first correlation degree between the key information and the search information and a second correlation degree between the structured information and the search information.

In one possible implementation, the acquisition module 301 is further configured to predetermine the structured information by:
extracting the structured information corresponding to the target webpage content based on a key field combination set for a webpage category to which the target webpage content belongs, for the target webpage content, where the structured information includes field information of a plurality of key fields indicated by the key field combination.

In one possible implementation, the acquisition module 301 is further configured to determine the key information by:
extracting individual text segments in the target webpage content;
determining a correlation degree between each text segment and the search information; and
selecting a text segment with a highest corresponding correlation degree as the key information, or selecting at least one text segment with a corresponding correlation degree greater than a first set threshold and integrating the at least one text segment into the key information.

In one possible implementation, when selecting, from the key information and the structured information, the information with the higher corresponding correlation degree as the search result matching the search information based on the first correlation degree between the key information and the search information and the second correlation degree between the structured information and the search information, the acquisition module 301 is configured to:
inputting the search information, and the key information and the structured information corresponding to the search information into a pre-trained neural network model to obtain a first correlation score for characterizing the first correlation degree and a second correlation score for characterizing the second correlation degree output by the neural network model; and
presenting information with a higher correlation score as the search result matching the search information based on the first correlation score and the second correlation score.

In one possible implementation, the acquisition module 301 is further configured to train the neural network model according to the following steps:
acquiring sample search information, sample key information and sample structured information of webpage content corresponding to the sample search information, and sample labels, where the sample labels are used to mark first sample correlation degrees between the sample key information and the sample search information and second sample correlation degrees between the sample structured information and the sample search information;
inputting the sample search information, the sample key information, and the sample structured information into the neural network model to be trained to obtain first sample correlation scores for characterizing the first sample correlation degrees and second sample correlation scores for characterizing the second sample correlation degrees output by the neural network model; and
determining a loss value of a current training based on the first sample correlation scores, the second sample correlation scores, and the sample labels, and adjusting parameters of the neural network model to be trained based on the loss value.

In one possible implementation, when prominently presenting the keyword in the key information that matches the search information, the presentation module 302 is configured to:
perform word segmentation on the key information to obtain individual segmented words; and
calculate a correlation degree between each obtained segmented word and the search information, and set a segmented word with a correlation degree between the segmented word and the search information greater than a second set threshold in the key information as in a prominent presentation form.

In the search result presentation apparatus provided by the embodiments of the present disclosure, the search result matching the search information may include one of the key information and the structured information of the webpage content, and the search result is presented in the presentation form matching the search result (the key information and the structured information correspond to different presentation forms, respectively). In this way, the search result can better match different search information, and the user can accurately determine whether the webpage content meets the user's search needs, and then decide whether to further consume the detailed content of the webpage, thereby improving the user's efficiency of browsing the search result.

For the description of the processing flow of each module in the apparatus and the interaction flow between each module, reference may be made to the related description in the above method embodiments, which will not be detailed here.

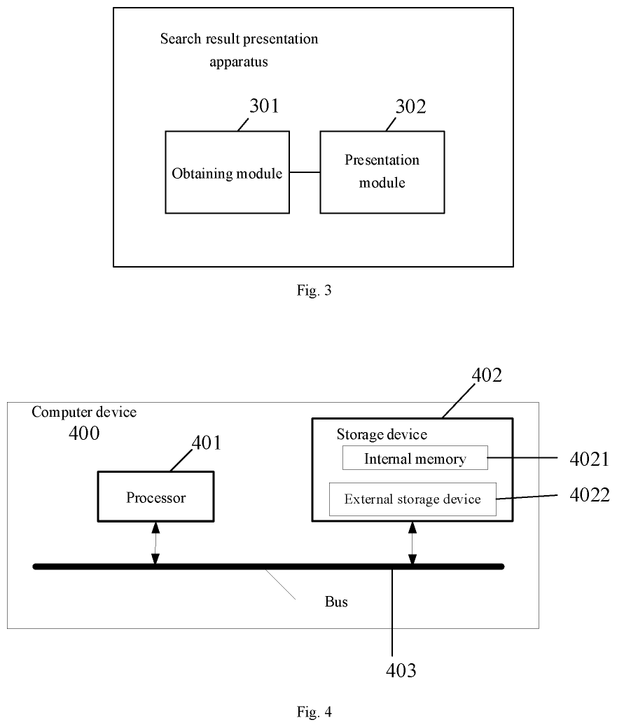

Based on the same technical concept, an embodiment of the present disclosure further provides a computer device. Referring to FIG. 4, which is a structural schematic diagram of a computer device 400 provided by an embodiment of the present disclosure, the computer device 400 includes a processor 401, a storage device 402, and a bus 403. The storage device 402 is configured to store an execution instruction, and includes an internal memory 4021 and an external storage device 4022. The internal memory 4021, also known as an internal storage device, is configured to temporarily store operation data in the processor 401 and data exchanged with the external storage device 4022 such as a hard disk. The processor 401 exchanges data with the external storage device 4022 through the internal memory 4021. When the computer device 400 is running, the processor 401 communicates with the storage device 402 through the bus 403, so that the processor 401 executes the following instructions:
acquiring a search result matching search information in response to receiving the search information, where the search result includes one of key information and structured information of target webpage content; and
presenting the search result in a presentation form corresponding to the search result.

The presentation form corresponding to the key information includes prominently presenting a keyword in the key information that matches the search information, and the presentation form corresponding to the structured information includes presenting field information of a plurality of key fields of the target webpage content in a structured manner.

In one possible implementation, in the instructions of the processor 401, the search result matching the search information is determined by:
acquiring individual search results, where the individual search results include the key information and the structured information; and
selecting, from the key information and the structured information, information with a higher corresponding correlation degree as the search result matching the search information based on a first correlation degree between the key information and the search information and a second correlation degree between the structured information and the search information.

In one possible implementation, in the instructions of the processor 401, the structured information is predetermined by:
extracting the structured information corresponding to the target webpage content based on a key field combination set for a webpage category to which the target webpage content belongs, for the target webpage content, where the structured information includes field information of a plurality of key fields indicated by the key field combination.

In one possible implementation, in the instructions of the processor 401, the key information is determined by:
extracting individual text segments in the target webpage content;
determining a correlation degree between each text segment and the search information; and
selecting a text segment with a highest corresponding correlation degree as the key information, or selecting at least one text segment with a corresponding correlation degree greater than a first set threshold and integrating the at least one text segment into the key information.

In one possible implementation, in the instructions of the processor 401, selecting, from the key information and the structured information, the information with the higher corresponding correlation degree as the search result matching the search information based on the first correlation degree between the key information and the search information and the second correlation degree between the structured information and the search information includes:
inputting the search information, and the key information and the structured information corresponding to the search information into a pre-trained neural network model to obtain a first correlation score for characterizing the first correlation degree and a second correlation score for characterizing the second correlation degree output by the neural network model; and
presenting information with a higher correlation score as the search result matching the search information based on the first correlation score and the second correlation score.

In one possible implementation, in the instructions of the processor 401, the neural network model is trained according to the following steps:
acquiring sample search information, sample key information and sample structured information of webpage content corresponding to the sample search information, and sample labels, where the sample labels are used to mark first sample correlation degrees between the sample key information and the sample search information and second sample correlation degrees between the sample structured information and the sample search information;
inputting the sample search information, the sample key information, and the sample structured information into the neural network model to be trained to obtain first sample correlation scores for characterizing the first sample correlation degrees and second sample correlation scores for characterizing the second sample correlation degrees output by the neural network model; and
determining a loss value of a current training based on the first sample correlation scores, the second sample correlation scores, and the sample labels, and adjusting parameters of the neural network model to be trained based on the loss value.

In one possible implementation, in the instructions of the processor 401, prominently presenting the keyword in the key information that matches the search information includes:
performing word segmentation on the key information to obtain individual segmented words; and
calculating a correlation degree between each obtained segmented word and the search information, and setting a segmented word with a correlation degree greater than a second set threshold in the key information as a prominent presentation form.

The embodiments of the present disclosure further provide a computer-readable storage medium having a computer program stored thereon. The computer program, when executed by a processor, causes the processor to perform the steps of the search result presentation method described in the above method embodiments. The storage medium may be a volatile or non-volatile computer-readable storage medium.

The embodiments of the present disclosure further provide a computer program product carrying program codes, where instructions included in the program codes may be used to perform the steps of the search result presentation method described in the above method embodiments, which may be specifically referred to the above method embodiments and will not be repeated here.

The above-mentioned computer program product may be specifically implemented by hardware, software, or a combination thereof. In an optional embodiment, the computer program product is embodied as a computer storage medium. In another optional embodiment, the computer program product is embodied as a software product, such as a software development kit (SDK) and the like.

It can be clearly understood by those skilled in the art that, for the convenience and brevity of description, for the specific working process of the above-described system and apparatus, reference may be made to the corresponding process in the foregoing method embodiments, which will not be repeated here. In the several embodiments provided by the present disclosure, it should be understood that the disclosed system, apparatus, and method may be implemented in other ways. The apparatus embodiments described above are only schematic. For example, the division of the units is only a logical function division, and there may be other division manners in actual implementation. For another example, multiple units or components may be combined or integrated into another system, or some features may be ignored or not implemented. In addition, the mutual coupling or direct coupling or communication connection as shown or discussed may be indirect coupling or communication connection through some communication interfaces, apparatuses or units, and may be electrical, mechanical, or in other forms.

The units described as separate components may or may not be physically separated, and the components displayed as units may or may not be physical units, that is, they may be located in one place or distributed on multiple network units. Some or all of the units may be selected according to actual needs to achieve the objectives of the solutions of the embodiments.

In addition, the individual functional units in the embodiments of the present disclosure may be integrated into one processing unit, or each unit may exist alone physically, or two or more units may be integrated into one unit.

If the functions are implemented in the form of a software functional unit and sold or used as an independent product, the functions may be stored in a non-volatile computer-readable storage medium executable by a processor. Based on this understanding, the nature of the technical solutions of the present disclosure or the part contributed by the technical solutions of the present disclosure over the prior art or part of the technical solutions may be embodied in the form of a software product, and the computer software product is stored in a storage medium and includes a plurality of instructions for causing a computer device (which may be a personal computer, a server, or a network device, etc.) to perform some or all of the steps of the methods described in the embodiments of the present disclosure. The above-mentioned storage medium includes various media that can store program codes, such as a USB flash disk, a mobile hard disk, a read-only memory (ROM), a random access memory (RAM), a magnetic disk, or an optical disc.

Finally, it should be noted that the above-described embodiments are only specific implementations of the present disclosure, which are used to illustrate the technical solutions of the present disclosure, but not to limit them. The protection scope of the present disclosure is not limited thereto. Although the present disclosure has been described in detail with reference to the foregoing embodiments, those of ordinary skill in the art should understand that any person skilled in the art within the technical scope disclosed by the present disclosure may still modify the technical solutions described in the foregoing embodiments or make easily conceivable changes, or equivalently replace some of the technical features; and these modifications, changes or replacements do not make the essence of the corresponding technical solutions deviate from the spirit and scope of the technical solutions of the embodiments of the present disclosure, and all of them should be covered by the protection scope of the present disclosure. Therefore, the protection scope of the present disclosure should be subject to the protection scope of the claims.

1. A search result presentation method, comprising:
in response to receiving search information, acquiring a search result matching the search information, wherein the search result comprises one of key information and structured information of target webpage content; and
presenting the search result in a presentation form corresponding to the search result,
wherein the presentation form corresponding to the key information comprises prominently presenting a keyword in the key information that matches the search information, and the presentation form corresponding to the structured information comprises presenting field information of a plurality of key fields of the target webpage content in a structured manner.

2. The method of claim 1, wherein the acquiring a search result matching the search information comprises:
acquiring individual search results, wherein the individual search results comprise the key information and the structured information; and
selecting, from the key information and the structured information, information with a higher corresponding correlation degree as the search result matching the search information based on a first correlation degree between the key information and the search information and a second correlation degree between the structured information and the search information.

3. The method of claim 1, wherein the structured information is predetermined by:
extracting the structured information corresponding to the target webpage content based on a key field combination set for a webpage category to which the target webpage content belongs, for the target webpage content, wherein the structured information comprises field information of a plurality of key fields indicated by the key field combination.

4. The method of claim 1, wherein the key information is determined by:
extracting individual text segments in the target webpage content;
determining a correlation degree between each text segment and the search information; and
selecting a text segment with a highest corresponding correlation degree as the key information, or selecting at least one text segment with a corresponding correlation degree greater than a first set threshold and integrating the at least one text segment into the key information.

5. The method of claim 2, wherein selecting, from the key information and the structured information, the information with the higher corresponding correlation degree as the search result matching the search information based on the first correlation degree between the key information and the search information and the second correlation degree between the structured information and the search information comprises:
inputting the search information, and the key information and the structured information corresponding to the search information into a pre-trained neural network model to obtain a first correlation score for characterizing the first correlation degree and a second correlation score for characterizing the second correlation degree output by the neural network model; and
presenting information with a higher correlation score as the search result matching the search information based on the first correlation score and the second correlation score.

6. The method of claim 5, wherein the neural network model is pre-trained according to the following steps:
acquiring sample search information, sample key information and sample structured information of webpage content corresponding to the sample search information, and sample labels, wherein the sample labels are used to mark first sample correlation degrees between the sample key information and the sample search information and second sample correlation degrees between the sample structured information and the sample search information;
inputting the sample search information, the sample key information, and the sample structured information into the neural network model to be trained to obtain first sample correlation scores for characterizing the first sample correlation degrees and second sample correlation scores for characterizing the second sample correlation degrees output by the neural network model; and
determining a loss value of a current training based on the first sample correlation scores, the second sample correlation scores, and the sample labels, and adjusting parameters of the neural network model to be trained based on the loss value.

7. The method of claim 1, wherein prominently presenting the keyword in the key information that matches the search information comprises:
performing word segmentation on the key information to obtain individual segmented words; and
calculating a correlation degree between each obtained segmented word and the search information, and setting a segmented word with a correlation degree between the segmented word and the search information greater than a second set threshold in the key information as in a prominent presentation form.

8. (canceled)

9. A computer device, comprising: a processor, a storage device, and a bus, wherein the storage device stores a machine-readable instruction executable by the processor, the processor communicates with the storage device through the bus when the computer device is running, and the machine-readable instruction, when executed by the processor, causes the processor to perform the steps of the search result presentation method comprising:
in response to receiving search information, acquiring a search result matching the search information, wherein the search result comprises one of key information and structured information of target webpage content; and
presenting the search result in a presentation form corresponding to the search result,
wherein the presentation form corresponding to the key information comprises prominently presenting a keyword in the key information that matches the search information, and the presentation form corresponding to the structured information comprises presenting field information of a plurality of key fields of the target webpage content in a structured manner.

10. A computer-readable storage medium, wherein a computer program is stored on the computer-readable storage medium, and the computer program, when executed by a processor, causes the processor to perform the steps of the search result presentation method comprising:
in response to receiving search information, acquiring a search result matching the search information, wherein the search result comprises one of key information and structured information of target webpage content; and
presenting the search result in a presentation form corresponding to the search result,
wherein the presentation form corresponding to the key information comprises prominently presenting a keyword in the key information that matches the search information, and the presentation form corresponding to the structured information comprises presenting field information of a plurality of key fields of the target webpage content in a structured manner.

11. The computer device of claim 9, wherein the acquiring a search result matching the search information comprises:
acquiring individual search results, wherein the individual search results comprise the key information and the structured information; and
selecting, from the key information and the structured information, information with a higher corresponding correlation degree as the search result matching the search information based on a first correlation degree between the key information and the search information and a second correlation degree between the structured information and the search information.

12. The computer device of claim 9, wherein the structured information is predetermined by:
extracting the structured information corresponding to the target webpage content based on a key field combination set for a webpage category to which the target webpage content belongs, for the target webpage content, wherein the structured information comprises field information of a plurality of key fields indicated by the key field combination.

13. The computer device of claim 9, wherein the key information is determined by:
extracting individual text segments in the target webpage content;
determining a correlation degree between each text segment and the search information; and
selecting a text segment with a highest corresponding correlation degree as the key information, or selecting at least one text segment with a corresponding correlation degree greater than a first set threshold and integrating the at least one text segment into the key information.

14. The computer device of claim 11, wherein selecting, from the key information and the structured information, the information with the higher corresponding correlation degree as the search result matching the search information based on the first correlation degree between the key information and the search information and the second correlation degree between the structured information and the search information comprises:
inputting the search information, and the key information and the structured information corresponding to the search information into a pre-trained neural network model to obtain a first correlation score for characterizing the first correlation degree and a second correlation score for characterizing the second correlation degree output by the neural network model; and
presenting information with a higher correlation score as the search result matching the search information based on the first correlation score and the second correlation score.

15. The computer device of claim 14, wherein the neural network model is pre-trained according to the following steps:
acquiring sample search information, sample key information and sample structured information of webpage content corresponding to the sample search information, and sample labels, wherein the sample labels are used to mark first sample correlation degrees between the sample key information and the sample search information and second sample correlation degrees between the sample structured information and the sample search information;
inputting the sample search information, the sample key information, and the sample structured information into the neural network model to be trained to obtain first sample correlation scores for characterizing the first sample correlation degrees and second sample correlation scores for characterizing the second sample correlation degrees output by the neural network model; and
determining a loss value of a current training based on the first sample correlation scores, the second sample correlation scores, and the sample labels, and adjusting parameters of the neural network model to be trained based on the loss value.

16. The computer device of claim 9, wherein prominently presenting the keyword in the key information that matches the search information comprises:
performing word segmentation on the key information to obtain individual segmented words; and
calculating a correlation degree between each obtained segmented word and the search information, and setting a segmented word with a correlation degree between the segmented word and the search information greater than a second set threshold in the key information as in a prominent presentation form.

17. The computer-readable storage medium of claim 10, wherein the acquiring a search result matching the search information comprises:
acquiring individual search results, wherein the individual search results comprise the key information and the structured information; and
selecting, from the key information and the structured information, information with a higher corresponding correlation degree as the search result matching the search information based on a first correlation degree between the key information and the search information and a second correlation degree between the structured information and the search information.

18. The computer-readable storage medium of claim 10, wherein the structured information is predetermined by:
extracting the structured information corresponding to the target webpage content based on a key field combination set for a webpage category to which the target webpage content belongs, for the target webpage content, wherein the structured information comprises field information of a plurality of key fields indicated by the key field combination.

19. The computer-readable storage medium of claim 10, wherein the key information is determined by:
extracting individual text segments in the target webpage content;
determining a correlation degree between each text segment and the search information; and
selecting a text segment with a highest corresponding correlation degree as the key information, or selecting at least one text segment with a corresponding correlation degree greater than a first set threshold and integrating the at least one text segment into the key information.

20. The computer-readable storage medium of claim 16, wherein selecting, from the key information and the structured information, the information with the higher corresponding correlation degree as the search result matching the search information based on the first correlation degree between the key information and the search information and the second correlation degree between the structured information and the search information comprises:
inputting the search information, and the key information and the structured information corresponding to the search information into a pre-trained neural network model to obtain a first correlation score for characterizing the first correlation degree and a second correlation score for characterizing the second correlation degree output by the neural network model; and
presenting information with a higher correlation score as the search result matching the search information based on the first correlation score and the second correlation score.

21. The computer-readable storage medium of claim 20, wherein the neural network model is pre-trained according to the following steps:
acquiring sample search information, sample key information and sample structured information of webpage content corresponding to the sample search information, and sample labels, wherein the sample labels are used to mark first sample correlation degrees between the sample key information and the sample search information and second sample correlation degrees between the sample structured information and the sample search information;
inputting the sample search information, the sample key information, and the sample structured information into the neural network model to be trained to obtain first sample correlation scores for characterizing the first sample correlation degrees and second sample correlation scores for characterizing the second sample correlation degrees output by the neural network model; and
determining a loss value of a current training based on the first sample correlation scores, the second sample correlation scores, and the sample labels, and adjusting parameters of the neural network model to be trained based on the loss value.
